(19) United States
(12) Patent Application Publication
(10) Pub. No.: US 2002/0023516 A1
(43) Pub. Date: Feb. 28, 2002

(54) Adjustable foot-operated control mechanism

(76) Inventors: Torsten Frobel, Hamburg (DE); Stephen Hoefig, Winsen (DE); Wolfgang Schweer, Neu Wolmstorf (DE); Michael Siemers, Hamburg (DE)

Correspondence Address: CROWEL & MORING, L.L.P., P.O. Box 14300, Washington, DC, 20044-4300, US

(21) Appl. No.: 09/900,447

(22) Filed: Jul. 9, 2001

(30) Foreign Application Priority Data
Jul. 8, 2000 (DE) 100 33 342.7

(51) Int. Cl. G05G 1/14

(52) U.S. Cl. 74/512

(57) ABSTRACT

An adjustable foot-operated control mechanism for motor vehicles is formed from at least one pedal having in each case a bearing arranged in a region of an end section of the pedal and having in each case a point of articulation onto a transmission element of a device to be actuated by the pedal. In this arrangement, the foot-operated control mechanism has at least one inner and one outer pedal bracket. The pedal is articulated on the inner pedal bracket and the inner pedal bracket is mounted on the outer pedal bracket. The inner pedal bracket is arranged displaceably with respect to the outer pedal bracket. When the inner pedal bracket is displaced, the pedal is rotated about a theoretical axis of rotation on the point of articulation.

### BACKGROUND AND SUMMARY OF THE INVENTION

The present invention relates to an adjustable foot-operated control mechanism, in particular for motor vehicles.

It is often desirable for the driver of a motor vehicle to adjust the pedal or pedals to be actuated by him, such as the brake pedal, the accelerator pedal and/or the clutch pedal (the clutch pedal being omitted in vehicles having an automatic gearbox), in accordance with his height or the requirements which he has with regards to his seat position. The driver may have the desire to bring the pedals closer to his feet or to move them further away. Seat adjustment generally does not suffice on its own for this purpose and so pedal adjustment ought to he provided in addition to the seat adjustment which is conventionally provided in vehicles.

In the prior art the German Published Patent Application DE 41 22 629, for example, discloses an adjustable pedal control mechanism for motor vehicles, having at least one pedal arm, having a setting arrangement for positionally displacing the pedal arm assigned to it in each case, and a securing device for fastening the pedal control mechanism to a motor-vehicle body. In this case, the pedal arms of the pedal control mechanism are arranged on a rotatable shaft and the pedal arms are set via a gear mechanism and an eccentrically mounted component which is connected thereto.

Furthermore, European Patent Document EP 0 936 527 A2 discloses a setting mechanism for a brake pedal and a clutch pedal, in which the pedal can be changed in its position relative to the vehicle seat by means of a spindle in each case.

In the case of these two settable pedal control mechanisms which are known from the prior art it has proven fundamentally disadvantageous that, in addition to the pedal itself for introducing the foot force, a transmission mechanism having an additional point of rotation and a type of intermediate lever for dissipating the force, for example the brake force, also has to be provided in order to prevent or compensate for a relative movement of the connecting point between the pedal and transmission mechanism by adjustment of the pedal. This is necessary, since the connection between the pedal and, for example the brake servo unit, if the pedal is a brake pedal, also has to be designed such that it can be set in accordance with the pedal position which is set.

Moreover, German Published Patent Application DE 42 30 980 also discloses to the expert a further, adjustable foot-operated control mechanism, in particular for use in motor vehicles.

The core concept in the case of this adjustable foot-operated control mechanism described therein is that the adjustment can be brought about by introducing a rotational movement directly onto the shaft. This produces a relatively cost-effective arrangement, since in comparison with a conventionally used foot-operated control mechanism without an adjusting mechanism relatively small changes are required. In this arrangement, only a slot-like guide for the shaft in the bracket and at least one adjusting disc in which a guide element engages are required in addition to the drive for the shaft.

In this foot-operated control mechanism it has proven disadvantageous that an arrangement of the adjusting disc is fixed, and so, at least in a lateral direction, only a limited option for varying the arrangement of the foot-operated control mechanism is possible.

An object of the present invention is therefore to provide an adjustable foot-operated control mechanism, in particular for motor vehicles, in which its arrangement can be varied more easily and the design of the foot-operated control mechanism is simplified.

According to the invention, this object is achieved in the case of an adjustable foot-operated control mechanism of the type mentioned above comprising at least one pedal having in each case a bearing arranged in the region of an end section of the pedal and having in each case a point of articulation onto an articulater for a transmission element to a device to be actuated by the pedal, the foot-operated control mechanism having at least one inner pedal bracket and one outer pedal bracket, the pedal being articulated on the inner pedal bracket and the inner pedal bracket being mounted on the outer pedal bracket in such a manner that the inner pedal bracket is arranged displaceably with respect to the outer pedal bracket, in which case when the inner pedal bracket is displaced the pedal is rotated about a theoretical axis of rotation on the point of articulation.

The foot-operated control mechanism according to the invention, in particular for motor vehicles, comprises at least one pedal having in each case a bearing arranged in the region of an end section of the pedal and having in each case a point of articulation onto a transmission element to a device to be actuated by the pedal. In this case, the foot-operated control mechanism has at least one inner and one outer pedal bracket. According to the present invention, the pedal is articulated on the inner pedal bracket and the inner pedal bracket is mounted on the outer pedal bracket, in which case the inner pedal bracket is arranged displaceably with respect to the outer pedal bracket.

If, during displacement of the inner pedal bracket the pedal is rotated about a so-called theoretical axis of rotation through the point of articulation of the pedal, then the pedal can be actuated in every set position desired without there having to be a complicated adjustment in the region of the transmission of force to the transmission element.

With an arrangement of this type a very compact construction can advantageously also be achieved by the pedal brackets being designed, for example, as bushings arranged one in the other. In another refinement of the brackets, the foot-operated control mechanism can be adapted to the existing construction space. Embodiments are thus also contemplated where the brackets are designed as rails or the like.

Moreover, according to certain preferred embodiments of the invention the device to be actuated in the case of a foot-operated control mechanism according to the invention and also the pedal, for example the brake pedal, the clutch pedal and/or the accelerator pedal, can be of the same design as is the case in conventionally used foot-operated control mechanisms which do not have any adjustable pedals.

In addition, it has proven advantageous according to certain preferred embodiments of the invention that the pedals can in each case be articulated individually and separately on corresponding pedal brackets which then, in turn, are secured in outer pedal brackets or even in each case in a separate, individual outer pedal bracket. It can therefore be achieved in a simple manner that the individual pedals can be adjusted separately and do not absolutely all have to be adjusted at the same time.

If the outer pedal bracket is arranged fixedly in the vehicle, the foot-operated control mechanism can be set exclusively via displacement of the first bracket with respect to the second bracket and can therefore be carried out very simply.

Other objects, advantages and novel features of the present invention will become apparent from the following detailed description of the invention when considered in conjunction with the accompanying drawings.

### BRIEF DESCRIPTION OF THE DRAWINGS

FIG. 1 shows, in a three-dimensional perspective view, an adjustable foot-operated control mechanism constructed in accordance with a preferred embodiment of the present invention;

FIG. 2 shows the adjustable foot-operated control mechanism from FIG. 1 in a view as seen from the driver's seat;

FIG. 3 shows the foot-operated control mechanism from FIG. 2 in a sectional side view along part of the line A-A in FIG. 2;

FIG. 4 shows, in a three-dimensional perspective view, a further, adjustable foot-operated control mechanism constructed in accordance with a second preferred embodiment of the invention;

FIG. 5 shows the adjustable foot-operated control mechanism constructed according to FIG. 4 in a view from the front or as seen from the driver's seat;

FIG. 6 shows the foot-operated control mechanism constructed according to FIG. 4 and FIG. 5 in a sectional view along the line A-A in FIG. 5;

FIG. 7 shows, in a view from the side, a foot-operated control mechanism constructed in accordance with a third preferred embodiment of the present invention;

FIG. 8 shows the adjustable foot-operated control mechanism from FIG. 7 in a view from the front or as seen from the driver's seat;

FIG. 9 shows a section along the line A-A in FIG. 8; and

FIG. 10 shows, in a perspective view, the foot-operated control mechanism according to the invention in accordance with the embodiment according to FIGS. 7, 8 and 9, where the pedal has been omitted for reasons of clarity.

### DETAILED DESCRIPTION OF THE DRAWINGS

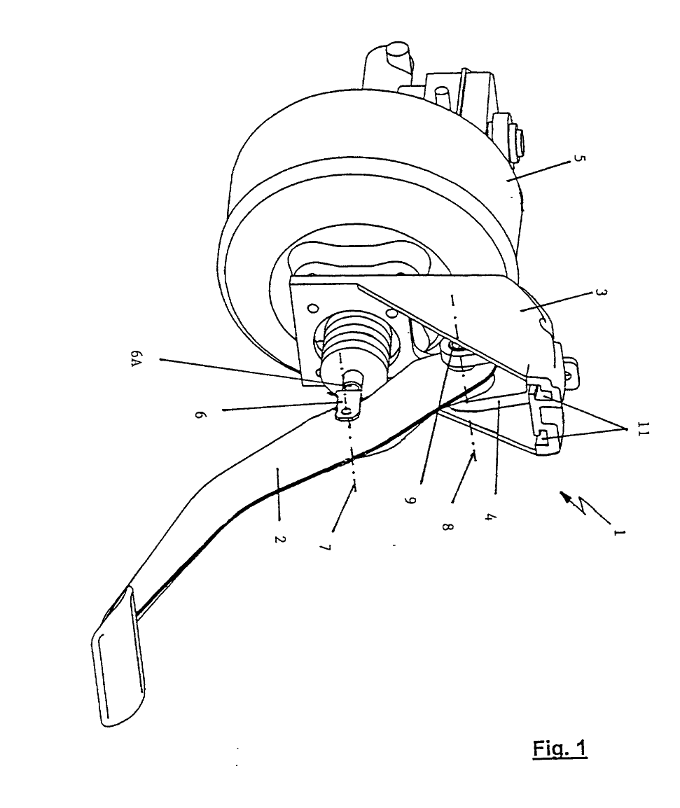

FIG. 1 shows an adjustable foot-operated control mechanism 1 in accordance with a first preferred embodiment of the present invention. As can be gathered from FIG. 1, for example, the adjustable foot-operated control mechanism 1 which is shown comprises a pedal 2 having a bearing 9 which is arranged in the region of an end section of the pedal 2 and via which the pedal 2 is connected to an inner pedal bracket 4. In this case, the pedal 2 has in each case an articulating means or articulater 6 onto a transmission element 6A which interacts with a device to be actuated by the pedal 2. In the present case, this device constitutes a brake device, specifically, in particular, a brake servo unit 5.

In the case of a pedal designed as a clutch or accelerator pedal, the device to be actuated is accordingly a clutch device or, for example, a throttle cable control.

The foot-operated control mechanism 1 has at least one inner pedal bracket 4 and one outer pedal bracket 3. In this case, the pedal 2 is articulated on the inner pedal bracket 4, as has already been mentioned, via a bearing 9 having an axis of rotation 8, and the inner pedal bracket 4 is mounted on the outer pedal bracket 3 in such a manner that the inner pedal bracket 4 is arranged displaceably with respect to the outer pedal bracket 3.

The outer pedal bracket 3 is preferably arranged fixedly in the vehicle, so that only the inner pedal bracket 4 is displaceable with respect to the outer pedal bracket 3 and therefore setting of the foot-operated control mechanism 1 is very simple.

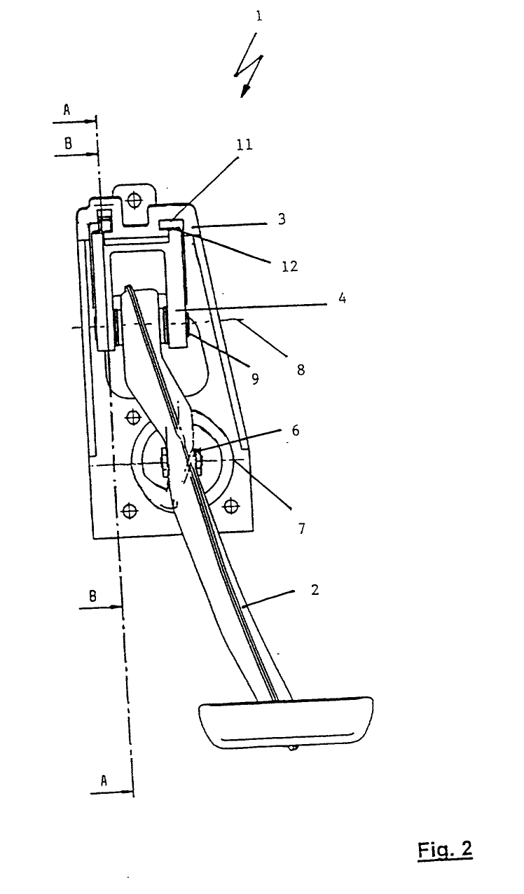

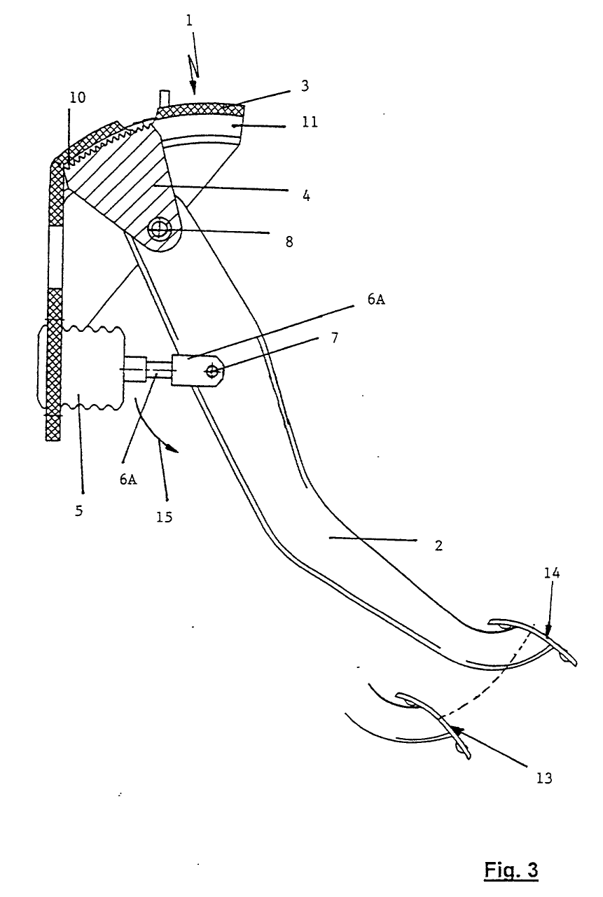

FIG. 2 and FIG. 3 each show different representations of the embodiment of FIG. 1. It is seen therein that the inner pedal bracket 4 is mounted in the outer pedal bracket 3, with this mounting here comprising a guide 11 in the outer pedal bracket 3 and a guide 12 in the inner pedal bracket 4.

According to the design which is shown, a toothing 10 in the form of a toothed ring is provided on the inner pedal bracket 4, it being possible for the toothed ring to be driven, specifically, for example, by an electric motor, by a toothed wheel or else by a hand wheel via a shaft and a toothed wheel.

According to the invention, the pedal brackets 3 and 4 are arranged with respect to each other in such a manner that when the inner pedal bracket 4 is displaced relative to the outer pedal bracket 3, the pedal brackets 3 and 4 are rotated in a circling manner towards each other about a theoretical axis of rotation through the point of articulation 7 in the articulating means 6.

A corresponding rotational movement is indicated in FIG. 3 by an arrow denoted by 15, in which case the pedal position 13 changes into the pedal position 14.

In the case of the adjusting mechanism shown, after the pedal 2 is adjusted, a complicated deflection of the force does not have to be undertaken, since the point of engagement of the pedal 2 on the transmission element 6A, which constitutes a connecting yoke here, always remains the same.

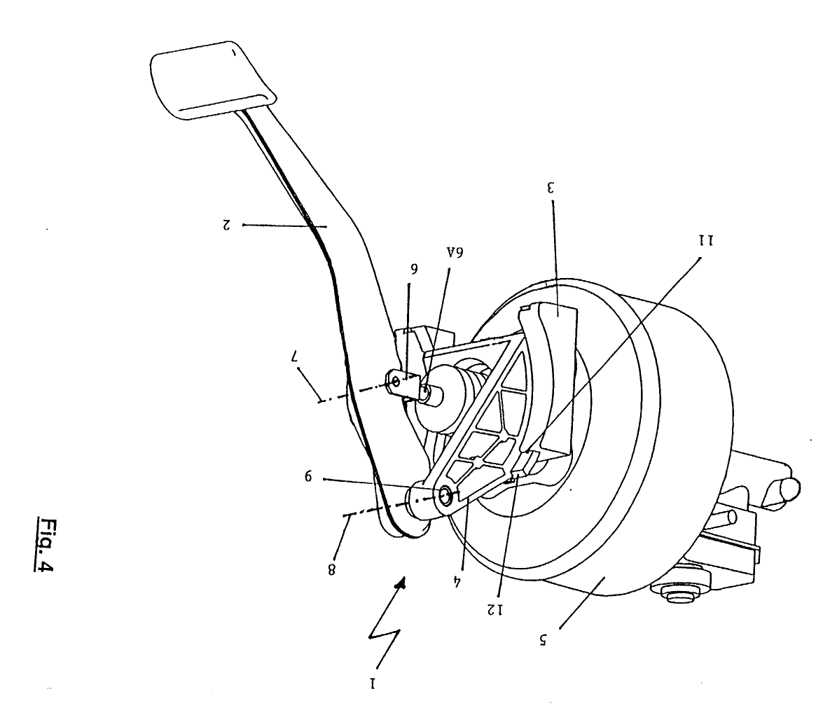

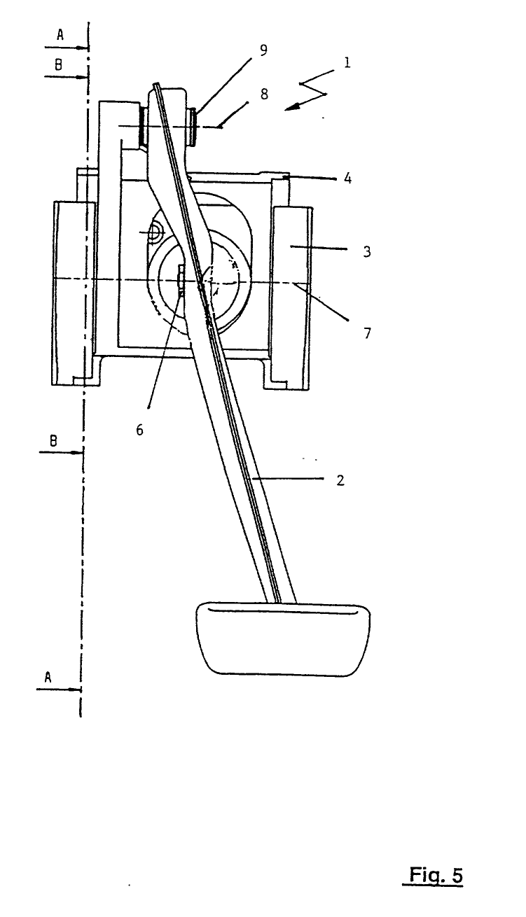

FIGS. 4 to 6 show figures corresponding to FIGS. 1 to 3 of a second preferred embodiment of the foot-operated control mechanism 1 according to the invention.

In FIGS. 4 to 6 parts corresponding to FIGS. 1 to 3 have also been provided with the same reference numbers. This second preferred embodiment which is shown is a very lightweight arrangement which has proven very advantageous on account of the saving on material costs and on account of the resultant saving on fuel during operation of the motor vehicle.

When comparing FIGS. 1 to 3 with FIGS. 4 to 6 it is apparent that in FIGS. 4 to 6 the inner pedal bracket 4 is firstly of a more filigree and therefore very lightweight design, and secondly, the outer pedal bracket 3 does not constitute a closed bushing, but rather is designed with side members laterally enclosing the inner pedal bracket 4.

As in the case of the previously shown embodiment of the present invention, a guide 12 having a toothing 10 is again provided on the inner pedal bracket 4. The pedal 2 again having an axis of rotation 8 via a bearing 9 is mounted in the inner pedal bracket 4. Provided on the pedal 2, also via a transmission element 6A, is a connection to a device to be actuated, in the present case again a brake servo unit 5, with the theoretical axis of rotation through the point of articulation 7.

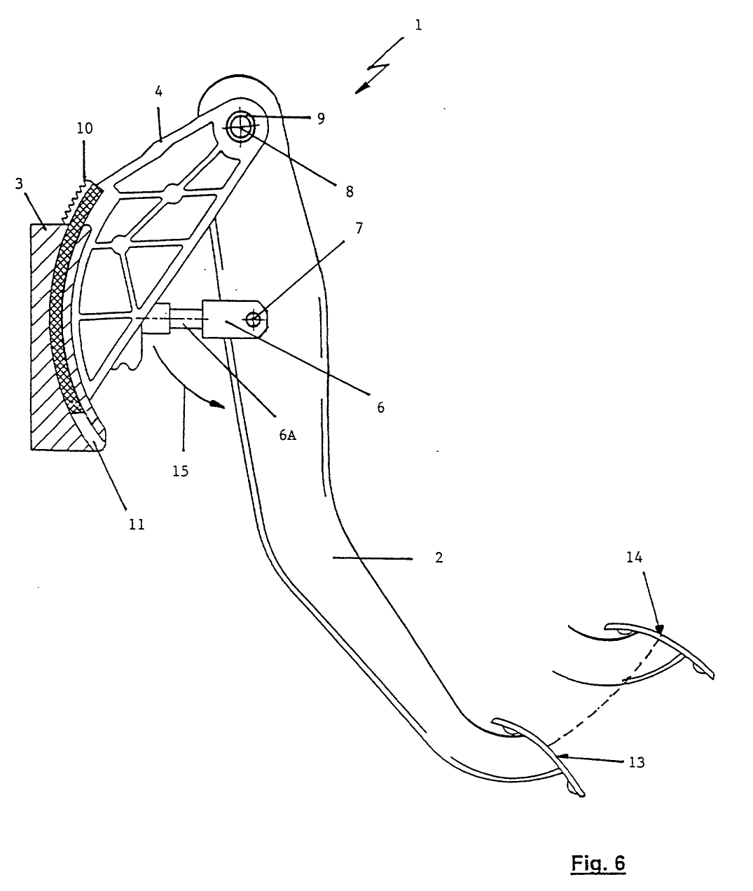

If a displacement is introduced via the toothing 10 of the inner pedal bracket 4, the inner pedal bracket 4 together with the pedal 2 rotates in the outer pedal bracket 3 about this theoretical axis of rotation through the point of articulation 7 in the direction illustrated by an arrow 15, and the pedal position 13 changes into the pedal position 14, which is illustrated again more precisely in FIG. 6.

It should be emphasized here again that according to the embodiments of the invention shown up to now the manner of functioning is illustrated in each case for a brake pedal. However, the same principle can be realized just as well for clutch and accelerator pedals. These can either be integrated together in an inner pedal bracket or can be provided with entirely dedicated inner and outer brackets which can then also be set individually or else in parallel or together in pairs, as desired.

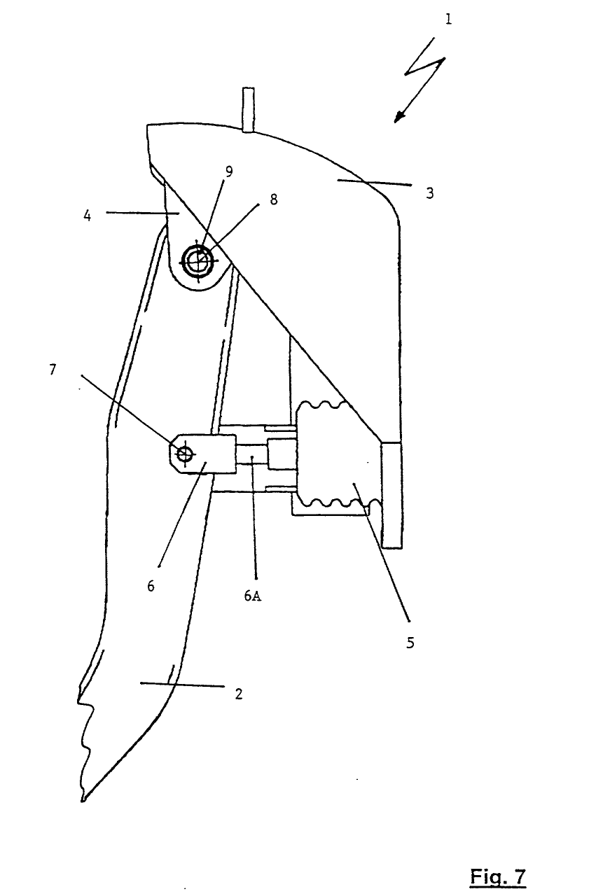

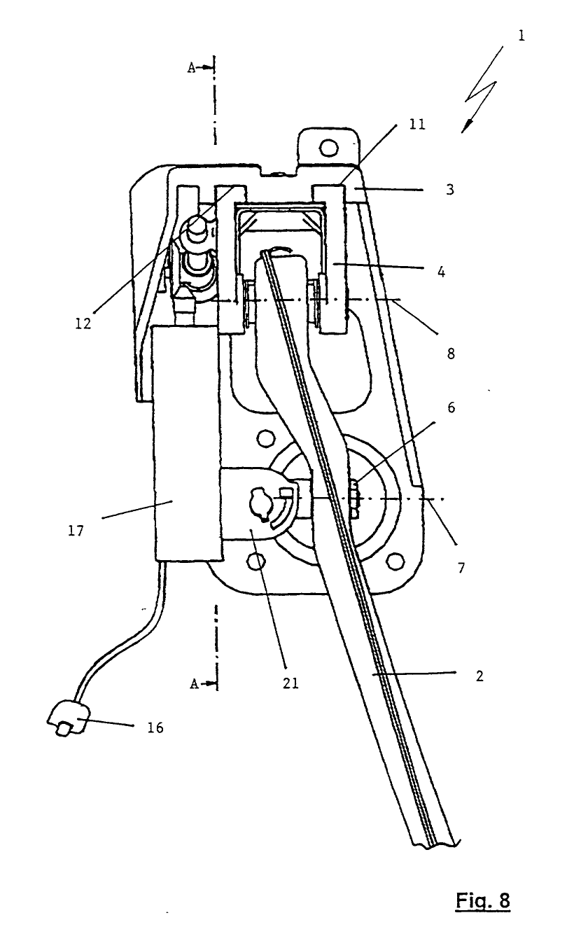

FIGS. 7 to 10 show a third embodiment of the adjustable foot-operated control mechanism 1 according to the invention, with an electronic setting mechanism being provided here for adjustment of the foot-operated control mechanism 1.

In the case of an electronic setting mechanism of this type which can be used according to the invention and can be driven via a motor 17, which in turn is preferably an electric motor, the integration of a memory function, for example, would be possible. It is therefore possible for each driver who drives the vehicle more frequently to be able to store his pedal position and, when he gets into the vehicle, to be able to correspondingly call up the data again, so that he obtains his already stored positional data directly without further adjusting and setting.

In addition, it would also be conceivable that certain values, for example height, can be input into a system and then an appropriate pedal position is assigned to these values. The pedals can then be subsequently readjusted at one's own discretion.

In FIGS. 7 to 10 the reference numbers of the first and second embodiments described are used again for components which are functionally identical.

As can now be gathered from FIGS. 7 to 10, again an outer pedal bracket 3 and an inner pedal bracket 4 are provided on which the pedal 2 is mounted in a manner such that it can move about its axis of rotation 8 via a bearing 9. Furthermore, the pedal has an articulating means 6 onto a transmission element 6A, which again transmits the movement of the pedal 2 to the device which is to be activated and in the present case is again a brake servo unit 5.

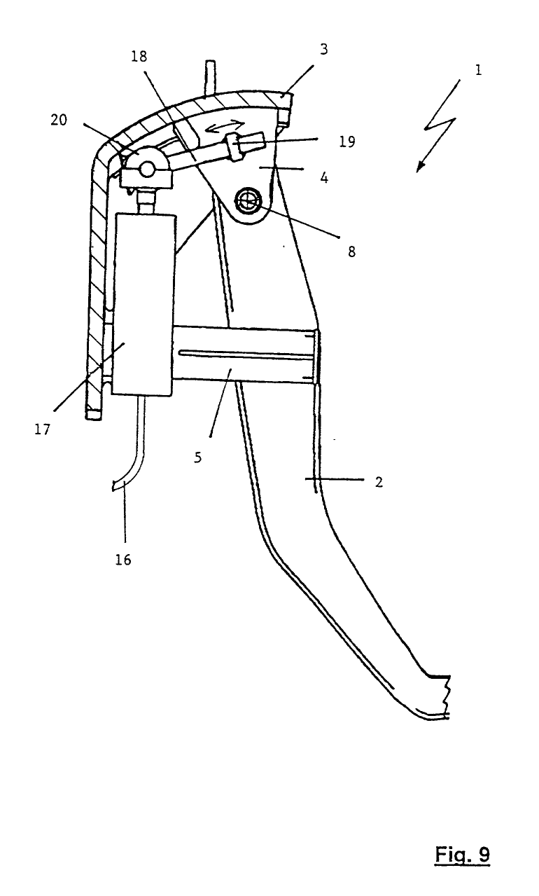

As can now be gathered in particular from FIG. 9, the displacement of the inner pedal bracket 4 with respect to the outer pedal bracket 3 takes place here in quite general terms via a spindle mechanism, in which case the two pedal brackets 3, 4 are displaced with respect to each other via a spindle.

In this case, a motor 17 which is again used here drives a step-up gear 20 which, in turn, drives a threaded rod 18 which is provided at the front with a type of joint 19 which, in the present case, serves in particular as a connecting eye between the threaded rod 18 and the inner pedal bracket 4.

The inner pedal bracket 4 can thus be displaced with respect to the outer pedal bracket 3 in the guide 11 of the outer pedal bracket 3 via the threaded rod 18, and the pedal 2 can therefore be set accordingly to the occupant on the driver's seat. Furthermore, as can be gathered from the figure, an actuating switch 16 is provided in order to switch on the motor 17 for the drive.

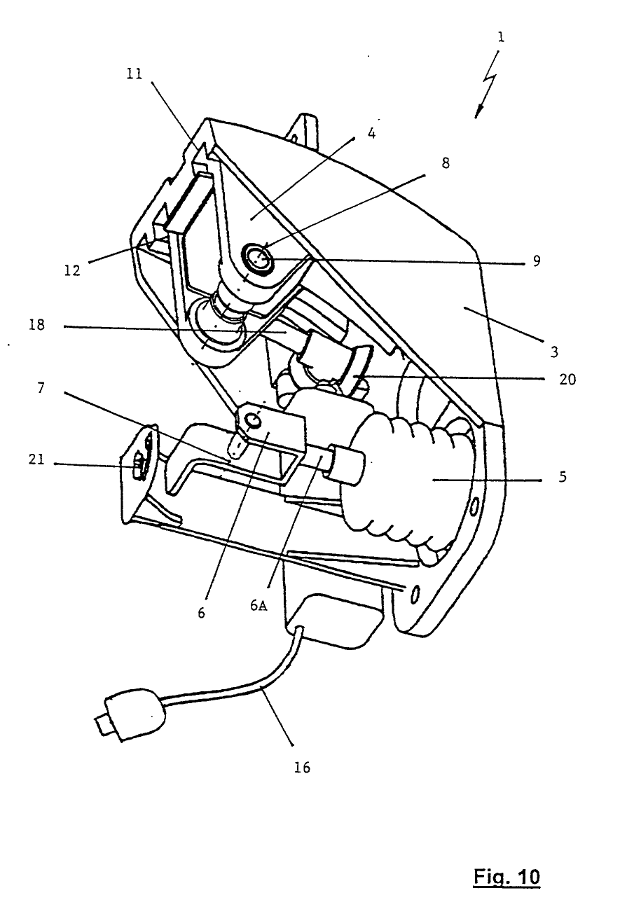

As can be gathered in particular from FIG. 10, a socket for a brake light switch 21 can more advantageously be provided in such a manner that the brake light switch is actuated by the transmission element 6A when the brake pedal 2 is actuated.

It can generally be summarized that no relative movement, for example with respect to the brake servo unit 5, is produced, in particular because of the kinematics of the foot-operated control mechanism 1, which kinematics are A illustrated in all of the embodiments and are achieved in particular by the mounting of the inner pedal bracket 4 in the outer pedal bracket 3 and by the rotational movement about the theoretical axis of rotation through the point of articulation 7, and so a very simple design of the means of adjusting the foot-operated control mechanism 1 is possible here.

By means of the design of an essentially curved guide 11 in the outer pedal bracket 3, in which guide the inner pedal bracket 4 is guided, a complicated mechanism having a large number of components for transmitting the force exerted on the pedal 2 to the device which is to be actuated, as is known from the prior art, is avoided and an extremely compact construction of the foot-operated control mechanism 1 is realized.

Furthermore, it has proven to be particularly advantageous that a virtually infinitely variable capacity to set the pedal 2 both in its height with respect to a vehicle floor and with respect to the distance from the driver is possible, so that an ergonomically optimum sitting position of the driver can be achieved firstly by the setting of the pedals 2 of the adjustable foot-operated control mechanism 1 according to the invention, and also with the aid of the seat adjustment which is generally used in vehicles.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. Adjustable foot-operated control mechanism, for motor vehicles, comprising at least one pedal having in each case a bearing arranged in the region of an end section of the pedal and having in each case a point of articulation onto an articulater for a transmission element to a device to be actuated by the pedal, the foot-operated control mechanism having at least one inner pedal bracket and one outer pedal bracket, the pedal being articulated on the inner pedal bracket and the inner pedal bracket being mounted on the outer pedal bracket in such a manner that the inner pedal bracket is arranged displaceably with respect to the outer pedal bracket, in which case when the inner pedal bracket is displaced the pedal is rotated about a theoretical axis of rotation on the point of articulation.

2. Adjustable foot-operated control mechanism according to claim 1, wherein the outer pedal bracket is arranged fixedly in the vehicle.

3. Adjustable foot-operated control mechanism according to claim 1, wherein the inner pedal bracket is displaced with respect to the outer pedal bracket via a guide in the outer pedal bracket and a corresponding guide in the inner pedal bracket.

4. Adjustable foot-operated control mechanism according to claim 1, wherein the guides are of essentially curved configuration in a guiding direction.

5. Adjustable foot-operated control mechanism according to claim 1, wherein at least one guide is provided with a toothing.

6. Adjustable foot-operated control mechanism according to claim 1, wherein the inner pedal bracket is displaced with respect to the outer pedal bracket via a spindle.

7. Adjustable foot-operated control mechanism according to claim 1, wherein the inner pedal bracket is displaced with respect to the outer pedal bracket in an electrically driven manner.

8. Adjustable foot-operated control mechanism according to claim 1, wherein the articulater is a connecting yoke.

9. Adjustable foot-operated control mechanism according to claim 1, wherein during a braking process the articulater activates a brake servo unit via a transmission element.

10. Adjustable foot-operated control mechanism according to claim 1, wherein the pedal is one of a brake pedal, a clutch pedal and an accelerator pedal.

11. Adjustable foot-operated control mechanism according to claim 1, wherein all of the pedals which are provided in the vehicle are arranged in an outer pedal bracket.

12. Adjustable foot-operated control mechanism according to claim 1, wherein all of the pedals which are provided in the An vehicle have dedicated outer pedal brackets.

13. A control assembly for controlling a motor vehicle device, comprising:
a first bracket which in use is fixed in position in a vehicle,
a second bracket supported by the first bracket,
a pedal engageable in use by a vehicle operator,
a pedal lever fixed to and movable with the pedal,
a first pivotal connection on the pedal lever with a device to be actuated,
a second pivotal connection on the pedal lever with the second bracket, said second pivotal connection being spaced from the first pivotal connection, and
an adjusting mechanism operable to adjustably move the second bracket with respect to the first bracket to thereby adjustably move the second pivotal connection and thereby adjust the pivotal position of the pedal lever and pedal with respect to the first pivotal connection.

14. A control assembly according to claim 13, wherein the pedal is a foot operated pedal.

15. A control assembly according to claim 14, wherein the device is a vehicle brake.

16. A control assembly according to claim 14, wherein the device is a vehicle accelerator.

17. A control assembly according to claim 14, wherein the device is a vehicle clutch.

18. A control assembly according to claim 13, wherein the adjusting mechanism includes interengaging curved guides on the first and second brackets and means for moving the second bracket along said guides with respect to the first bracket.

19. A control assembly according to claim 13, wherein the adjusting mechanism includes electronic memory means operable to initiate predetermined adjusting movements of the pedal independence on stored characteristics.

20. A control assembly according to claim 19, wherein the stored characteristics include operator sizes.

21. A control assembly according to claim 19, wherein the stored characteristics include characteristics for a plurality of different operators.

22. A passenger vehicle having a device in the form of one of a vehicle brake servo unit, a vehicle accelerator unit, and a clutch unit, and a control assembly,
said control assembly comprising:
a first bracket which in use is fixed in position in a vehicle,
a second bracket supported by the first bracket,
a pedal engageable in use by a vehicle operator,
a pedal lever fixed to and movable with the pedal,
a first pivotal connection on the pedal lever with a device to be actuated,
a second pivotal connection on the pedal lever with the second bracket, said second pivotal connection being spaced from the first pivotal connection, and
an adjusting mechanism operable to adjustably move the second bracket with respect to the first bracket to thereby adjustably move the second pivotal connection and thereby adjust the pivotal position of the pedal lever and pedal with respect to the first pivotal connection.

23. A passenger vehicle according to claim 22, wherein the pedal is a foot operated pedal.

24. A passenger vehicle according to claim 23, wherein the adjusting mechanism includes interengaging curved guides on the first and second brackets and means for moving the second bracket along said guides with respect to the first bracket.

25. A passenger vehicle according to claim 23, wherein the adjusting mechanism includes electronic memory means operable to initiate predetermined adjusting movements of the pedal independence on stored characteristics.

26. A passenger vehicle according to claim 25, wherein the stored characteristics include operator sizes.

27. A passenger vehicle according to claim 25, wherein the stored characteristics include characteristics for a plurality of different operators.

28. A passenger vehicle according to claim 23, wherein the passenger has a plurality of said devices, and wherein respective ones of said control assemblies are provided for each of the devices.
